(19) United States
(12) Patent Application Publication
(10) Pub. No.: US 2022/0341113 A1
(43) Pub. Date: Oct. 27, 2022

(54) SEDIMENT RETAINING STRUCTURE IN WATER COURSES

(71) Applicant: OFFICINE MACCAFERRI S.p.A., Zola Predosa (BO) (IT)

(72) Inventors: Paolo BIANCHINI, Pogliano Milanese, Milan (IT); Michele LARCHER, Bolzano (IT)

(21) Appl. No.: 17/761,307

(22) PCT Filed: Sep. 18, 2020
(86) PCT No.: PCT/IB2020/058701

§ 371 Date: Mar. 17, 2022

(30) Foreign Application Priority Data
Sep. 18, 2019 (IT) 102019000016637

(51) Int. Cl. E02B 8/02; E02B 3/02; E02B 5/08

(52) U.S. Cl. CPC E02B 8/023; E02B 3/023; E02B 5/085

(57) ABSTRACT

A sediment retaining structure in water courses including a net which is arranged transversely so as to occupy all the bed of the water course. At least one opening having a width less than the width of the bed is formed on the bottom of the net which delimits at least one side thereof.

### FIELD OF THE INVENTION

The present invention relates to a sediment retaining structure in water courses.

Reference is made herein particularly to sediment retaining structures for construction, by way of non-limiting example along water courses in which a consistent transport of solids or sediment takes place following flood flows, such as, for example, flows of debris, mud slides or hyper-concentrated currents.

### TECHNOLOGICAL BACKGROUND

It is known to process sediments in water flows by means of structures which are also known as embankments. These retaining structures are hydraulic engineering constructions which are positioned transversely relative to the bed of a water course. The object thereof is to reduce the gradient of the water courses and to retain the quantity of sediment, that is to say, the solid material, which is transported by the water course, for example, in the event of flood peaks.

Conventional embankments can be constructed from cement, masonry, earth, wood and gabions, that is to say, metal containers filled with pebbles and rocks. These embankments are constituted by a wall with a generally trapezoidal cross-section having the face thereof directed upstream or downstream in a vertical manner and a foundation which is embedded in the bed and in the banks, on which the wall itself is erected. The discharge section is arranged in the central upper portion of the construction and is defined laterally by the wall portions, the so-called wings, which extend from the discharge section as far as the banks. The purpose of the discharge section is to contain the water course under normal discharge conditions, thereby preventing the current from being able to erode the banks of the construction or possibly to avoid it.

There are also known selective embankments which are constructed similarly to conventional embankments and which are intended to retain the material having a relatively coarse particle size travelling from upstream in the event of a flood. In order to perform this function, the discharge section has dimensions which depend on the particle size of the material which it is intended to retain. The opening may be produced in different manners; it may be constituted by a simple slot or by a grill, which is horizontal or vertical and which may contain steel elements.

WO 2014/141096 describes a sediment retaining structure which uses a metal net, for example, with double-twist rings or mesh, for constructing retaining structures which are not completely filled in the initial phase of the flood and which apply a lamination action during the flood peak. This sediment retaining structure is configured to allow the passage of the solid flow during the initial phase and the final phase of the flood wave, while it is capable of retaining the solid material during the flood peak by applying an effect of lamination of the solid flow, reducing the peak value thereof. The mechanism for intercepting the solid material is brought about according to a principle of the hydrodynamic type, and not a mechanical screen.

The retaining structure described in WO 2014/141096 provides for a discharge section which is substantially trapezoidal and which is delimited in the horizontal extent thereof by lateral walls, as can be seen in the example of FIG. 1. The upper portion of the discharge section is covered by a metal net, while the lower portion of the discharge section defines a horizontal slot which is laterally delimited by the lateral walls. The depth of this horizontal slot has dimensions in accordance with the deposit which it is intended to obtain upstream of the retaining structure and the hydrodynamic characteristics and stream capacity characteristics of the current.

During the construction of the retaining structures of the type indicated above, it is fundamental to correctly size and configure the discharge section. In accordance with the need for lamination required, the lateral walls may be constructed in such a manner that the masonry wings delimit a horizontal slot which involves the entire width of the bed or only a portion thereof.

Carrying out masonry constructions in the natural environments involved with water courses always encounters more resistance as a result of the substantial environmental impact of such constructions as a result of the need to transport cement and stone materials to the location. Furthermore, carrying out masonry constructions may be expensive and complex, especially when they are carried out in inaccessible regions. Furthermore, it is often the case that the existing constructions have to be modified as a result of the change in conditions of the water course. In this case, the modification of the masonry constructions is particularly difficult and not always possible, for which reason there is felt a need for an effective, convenient and economical solution.

Therefore, the need has arisen to provide a sediment retaining structure in water courses which allows the lamination results of the structures of the known type to be achieved through an opening of predetermined dimensions, but without having to carry out, for the lateral definition of the discharge section, new masonry constructions or the modification of existing masonry constructions.

### Statement of Invention

An object of the present invention is to solve the problems of the prior art and to meet the needs set out above. Another object of the invention is to provide a sediment retaining structure which is simple and economical, and easy to construct even in inaccessible areas. Another object of the invention is to provide a sediment retaining structure which provides effective lamination in the event of flood waves. Another object of the invention is to provide a sediment retaining structure with a bottom opening which has predetermined dimensions apart from the formation of the bed and the dams of the water course, and independently of the erection of new masonry constructions or the modification of existing masonry constructions. Another object of the invention is to provide a sediment retaining structure which is resistant and durable, without any need for frequent maintenance operations.

To this end, the invention includes one or more of the features described below and defined in the claims.

According to a specific aspect, a sediment retaining structure in water courses comprises a net which is arranged transversely so as to occupy all the bed of the water course. There is formed on the bottom of the bed, therefore on the bottom of the net, at least one opening having a width less than the width of the bed. The opening is thus delimited by the net at least at one side thereof. Furthermore, the opening is also delimited by the net at the upper side. Preferably, the opening is delimited at both sides by the net. According to a preferred variant, the at least one opening is substantially a quadrangular opening with an upper side and two sides delimited by the net and a lower side which is delimited by the bed of the water course. The lateral delimitation of the at least one opening by means of the net allows a substantial flexibility of design and construction of the sediment retaining structure because the extent of the net at the side of the opening allows the construction of an opening having desired lateral dimensions without having to use masonry constructions or the like.

According to a particular aspect, the net is fixed to one or more tie rods. The tie rods may be peripheral tie rods which run substantially along the entire perimeter of the net itself. Preferably, there are provided one or more peripheral tie rods which run along the perimeter of the opening which is delimited by the net. Using tie rods, which can be positioned and fixed to the ground by means of simple anchoring members, allows easy and rapid construction of the sediment retaining structure, including in inaccessible zones and on steeply sloping gradients.

According to another particular aspect, the opening in the net of the sediment retaining structure is delimited at the upper side by a rigid bar. Preferably, but in a non-limiting manner, the rigid bar is fixed at the ends thereof to respective transverse ropes. Using a rigid bar allows good definition of the upper side of the opening. Furthermore, with a rigid bar it is possible to correctly tension the transverse ropes. A rigid bar further provides a good support for the rope with a triangular extent which serves to close the vertical wall of the slot. Furthermore, a great force may be applied to the rigid bar by means of a tensioning member.

According to another aspect, the retaining structure comprises at least one upper transverse tie rod to which the upper side of the net is fixed. The retaining structure comprises at least one lower transverse tie rod. At the upper side of the opening, the net is fixed to a portion of the lower transverse tie rod. The retaining structure comprises at least one pair of lateral ropes which each run along a respective side of the net as far as the lower limit of the side of the opening and which continue in a vertical direction along the side of the opening until they meet the lower transverse tie rod. Preferably, though in a non-limiting manner, each lateral rope is extended by being bent beyond the lower transverse tie rod. In particular, each lateral rope is bent in a direction inclined downwards until being fixed to the bed in the manner of a stay. This structure is resistant and is further easy to construct, allowing the construction of an opening at the bottom of the net with given dimensions, without any need for construction operations involving new masonry or modifications of an existing masonry construction.

### BRIEF DESCRIPTION OF THE DRAWINGS

Additional features and advantages will be appreciated from the following detailed description of a preferred embodiment with reference to the appended drawings which are given by way of non-limiting example and in which:

FIG. 1 is a front view of a sediment retaining structure of the known type described above,

FIG. 2 is a front view of a sediment retaining structure incorporating features of the present invention, and

FIG. 3 is a view to an enlarged scale of a construction detail of a lower lateral portion of the retaining structure of FIG. 2.

### DETAILED DESCRIPTION

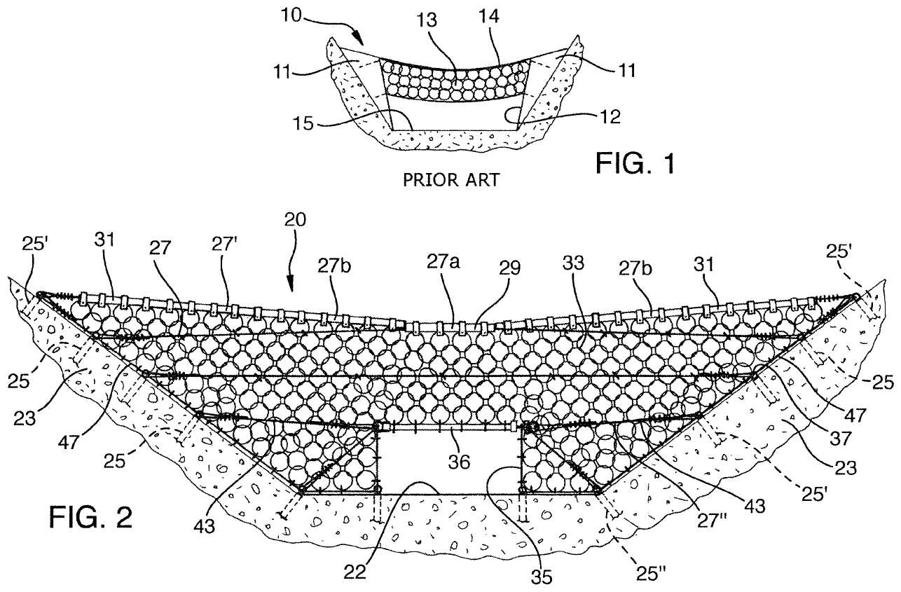

FIG. 1 is a front view of a sediment retaining structure of the known type described, for example, in the document WO 2014/141096. This structure of the prior art provides for a discharge section of the water course which has a substantially trapezoidal form and which is delimited in the horizontal extent thereof by lateral walls 11. The discharge section comprises an upper portion which is covered by a metal net 13 and an open lower portion which defines a horizontal slot 12. The metal net 13 is supported by an upper coupling rope 14 which runs transversely from one lateral wall 11 to the other. The horizontal slot 12 is delimited laterally by the lateral walls 11. The horizontal slot 12 extends in a vertical direction between the lower edge of the net 13 and the bed 15 of the water course. The height of the horizontal slot 12 has dimensions in accordance with the sediment deposit which is intended to be obtained upstream of the retaining structure and the hydrodynamic characteristics, as well as the stream capacity of the current.

With reference now to FIG. 2, there is illustrated a sediment retaining structure 20 in water courses which incorporates aspects of the present invention. Such a structure is configured to allow the passage of the solid flow during an initial phase and a final phase of the flood wave and is capable of retaining the solid material during the peak of the flood by applying an effect of lamination of the solid flow, reducing the peak value thereof by allowing the solid material to pass in the initial and final phases and also allowing a construction which may be considered to be self-cleaning to be carried out. It is important to understand that the mechanism for intercepting the solid material is of the hydrodynamic type rather than of the filter or mechanical screen type.

The retaining structure 20 is arranged transversely with respect to the bed 22 of a water course. The retaining structure 20 extends from the two banks 23 of the water course. There are arranged on the banks 23 anchoring members 25, for example, which are driven or cemented in the ground of the banks 23. The anchoring members 25 on the opposing banks 23 are arranged two by two at the same height. A corresponding tie rod 27 is fixed to each pair of anchoring members 25 which are positioned at the same height on the two banks 23. The tie rods 27 may be of different types, for example, constructed with metal ropes with strands or with helical ropes or by means of metal bars or other elongate elements of the type. The ends of the tie rods 27 are fixed to the respective anchoring members 25 by means of systems of the generally known type, for example, with cable ties, tensioning members, clamps, clips and similar devices. The tie rods 27 have a generally horizontal progression but the upper tie rod 27′ can take up a different configuration. In particular, the upper tie rod 27′ may be constructed in such a manner that a central portion 27a thereof is adjacent to the tie rod 27 immediately below. The upper tie rod 27′ thereby takes up a configuration in which the central portion 27a is horizontal while the lateral portions 27a adjacent thereto are inclined upwards from the centre towards the banks 23 and the anchoring members 25′ of the tie rod 27′. One method of obtaining this configuration is to provide a tube 29 which has a length equal to the central portion 27a of the upper tie rod 27′ and into which to pass both the upper tie rod 27′, in order to protect it from damage caused by the transport of sediment in the case of an overflow of the construction, and the tie rod 27 which is immediately below it so as to bring together the two tie rods 27, 27′ in a central zone of the retaining structure 20. Preferably, the lateral portions 27b of the upper tie rod 27′ are also inserted in corresponding tubes 31 or tube portions. The central portion 27a of the upper tie rod 27′ and the tie rod immediately below it can also be brought together with means other than the tube 29, for example, by means of rings, clips, ties, coiled members and the like.

At the ends of one or more tie rods, there may be applied energy dissipation members of the generally known type (not illustrated). The energy dissipation members allow the energy of the impact on the retaining structure to be absorbed, for example, by becoming deformed in accordance with the force applied thereto, bringing about an overall deformation of the construction.

A net 33 which takes up virtually the entire discharge section of the water course is fixed to the tie rods 27, from the upper tie rod 27′, along the banks 23 as far as the bottom of the bed 22, with the exception of a bottom opening 35 which has predetermined dimensions. The dimensions of the opening 35 are calculated during the design of the retaining structure 20. The particular formation of the retaining structure 20 of the present invention allows the construction of an opening 35 which has specific dimensions, almost independent of the formation of the bed 22 and the banks 23 of the water course, and particularly of the slope thereof and mutual spacing, therefore eliminating the need for construction of walls or lateral wings, as in the retaining structures of the prior art.

The net 33 may be a metal net, by way of non-limiting example of the type with rings, or with square or rhomboid mesh, or again by way of non-limiting example a double-twist net with hexagonal mesh. The upper side of the net 33 is fixed to the upper tie rod 27′, for example, by means of clips, ties, coils or another system suitable for the purpose. The net 33 may also be fixed in the intermediate positions thereof to other possible tie rods 27. The number of tie rods 27 used in a particular construction of a retaining structure 20 depends on the characteristics of the water course, the height and the inclination of the banks 23 and the height and the formation of the discharge section, that is to say, the section in which the water course runs under the flood conditions defining the flood bed.

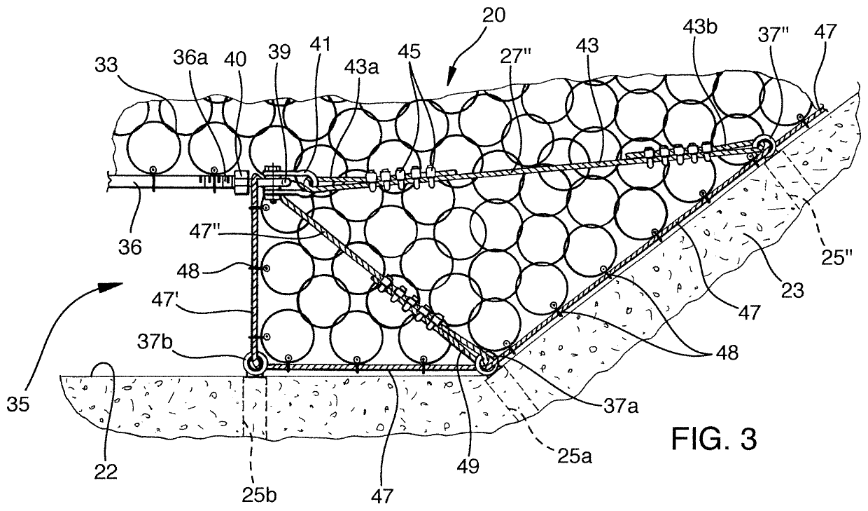

FIG. 3 is a view, to an enlarged scale, of a detail of the configuration of the opening 35. On the bottom of the bed 22, the net 33 extends from the two sides of the opening 35 as far as the lateral banks of the section. The opening 35 is therefore laterally delimited by the net 33. A lower tie rod 27″ is provided at a predetermined height from the bottom of the bed 22 and defines the upper limit of the opening 35 in the retaining structure 20. In particular, the lower tie rod 27″ may comprise a rigid bar 36 or other structural element which is preferably not flexible. At each of the ends 36a thereof, the rigid bar 36 comprises or is connected to a ring 39 or other connector, to which there is fixed one end 43a of a lateral portion 43 of the lower tie rod 27″, with the possible but unnecessary interposition of a clamp 41 or the like. The end 43a may, for example, be bent in a ring-like manner and closed about itself by means of cable clips 45. At the other end 43b, the lateral portion 43 of the tie rod 27″ is fixed similarly to the corresponding anchoring member 25″ and in particular to the ring 37″ which projects therefrom.

At one or both ends 36a thereof, the rigid bar 36 is preferably threaded. In this case, the ring 39 may be fixed, for example, welded or constructed in an integral manner, with a nut 40 which is screwed to the corresponding end 36a of the rigid bar 36. In this manner, one or two tensioning members are constructed at the ends of the rigid bar 36. By screwing the nut 36 on the end 36a of the rigid bar 36 after fixing the lateral portion 36a of the lower tie rod 27″ to the ring 39, it is possible to apply a great tension from bank to bank, with the advantage of producing optimum tension on the upper side of the opening 35 and, as will be described below, on the structure of ropes which defines the sides of the opening 35 and which provides for a bracing member to be constructed.

Two ropes 47 are provided at each side of the retaining structure 20 in order to fix the sides of the net 33 in the region of the sides 23 of the water course. To this end, an end of each of the two ropes 47 is fixed to the upper anchoring member 35, where the upper tie rod 27′ is fixed. The rope 47 runs over the side 23 of the water course and is retained there by passing through the rings 37 of each anchoring member 25. After being passed through the ring 37″ of the anchoring member 25″, to which the lower tie rod 27″ is fixed, the rope 47 continues towards the bottom of the bed 22 until it passes into the ring 37a of an anchoring member 25a which is positioned approximately in the zone in which the side 23 of the water course joins the bottom zone of the bed 22. If the bed 22 is irregular or the transition zone is not clearly defined, there are provided various anchoring members 25a in such positions that the rope 47 can follow the progression of the ground without moving away from it excessively. The object of the rope 47 is in fact to fix the net 33 laterally, over the entire contour and the base of the discharge section, without there being spaces and openings which are too extensive between the net and ground with the exception of the opening 35 which has predetermined dimensions and which is positioned at the bottom of the bed 22. The net 33 may be fixed to the rope 47 at locations 48 which are spaced apart regularly to a greater or lesser extent by means of rings, clips, ties, clamps or other similar means.

Each rope 47 also passes into the ring 37b of an anchoring member 25b which is positioned on the bottom of the bed 22, in a lateral position which defines the lateral extent of the opening 35. In other words, the spacing between the anchoring members 25b and/or the rings 37b at the bottom of the bed 22 defines the predetermined width of the opening 35. After passing through the ring 37b, the rope 47 travels over a substantially vertical portion 47′ which delimits the side of the opening 35 and which defines the height thereof with respect to the ground. In this case, the net 33 is also fixed to the vertical portion 47′ of the rope 47 at the side of the opening 35 in locations 48 by means of rings, clips, ties, clamps or other similar means.

The rope 47 then passes through the ring 39 which is positioned at the end of the central bar 36 in order to be returned with an inclined portion 47″ thereof towards the ring 37a. In this manner, the inclined portion 47″ substantially acts as a brace which fixes in position the central bar 36 during the thrust applied to the net 33 by a flood flow. The end 49 of the rope 47 may be fixed to the ring 37a, for example, by forming an end eyelet gripping the end of the rope 47 about itself with cable clips or similar systems.

Naturally, a number of variants are possible with respect to what has been described above, all being included within the scope and the spirit of the present invention. For example, it is possible to construct more than one opening in the bottom of the net, having identical or different dimensions, both in terms of width and in terms of height. These openings are delimited by ropes and/or tie rods having a perimeter, to which the net is fixed. Another variant provides for the net to delimit a single side of the opening, as well as the upper side thereof. In this case, both the base of the opening and the other side thereof are delimited by the bed of the water course. Another variant provides for the construction of masonry constructions on one or both banks of the water course, for example, in order to stabilize subsiding banks or in the case of very irregular banks. In this case, at least a portion of the anchoring members, particularly the anchoring members of the transverse tie rods, could be fixed to the masonry constructions. The opening at the bottom of the net has in any case an extent less than the spacing between the masonry constructions, that is to say, less than the width of the bed of the water course.

Naturally, the principle of the invention remaining the same, the forms of embodiment and details of construction may be varied widely with respect to those described and illustrated without thereby departing from the scope of the present invention.

1. A sediment retaining structure in water courses, comprising a net which is arranged transversely so as to occupy all the bed of the water course, at least one opening having a width less than the width of the bed being formed on the bottom of the net which delimits at least one side thereof.

2. The retaining structure according to claim 1, wherein the net is fixed to one or more peripheral tie rods which run substantially along an entire perimeter of the net itself.

3. The retaining structure according to claim 1, comprising one or more peripheral tie rods which run along a perimeter of the opening which is delimited by the net.

4. The retaining structure according to claim 1, wherein the at least one opening is substantially a quadrangular opening with an upper side and two sides delimited by the net and a lower side which is delimited by the bed of the water course.

5. The retaining structure according to claim 4, wherein the opening is delimited at the upper side by a rigid bar.

6. The retaining structure according to claim 5, wherein the rigid bar is fixed at the ends thereof to respective transverse ropes.

7. The retaining structure according to claim 1, comprising at least one upper transverse tie rod to which an upper side of the net is fixed, at least one lower transverse tie rod, to a portion of which the net is fixed at an upper side of the opening, and at least one pair of lateral ropes which each run along a respective side of the net as far as a lower limit of the side of the opening and which continue in a vertical direction along the side of the opening until they meet the lower transverse tie rod.

8. The retaining structure according to claim 7, wherein each lateral rope is extended by being bent beyond the lower transverse tie rod in a direction inclined downwards until being fixed to the bed in the manner of a stay.
